(19) United States
(12) Patent Application Publication
(10) Pub. No.: US 2024/0417312 A1
(43) Pub. Date: Dec. 19, 2024

(54) GLASS

(71) Applicant: AGC Inc., Tokyo (JP)

(72) Inventors: Naoki KANNO, Tokyo (JP); Shigeki SAWAMURA, Tokyo (JP)

(73) Assignee: AGC Inc., Tokyo (JP)

(21) Appl. No.: 18/820,034

(22) Filed: Aug. 29, 2024

Related U.S. Application Data
(63) Continuation of application No. PCT/JP2023/007751, filed on Mar. 2, 2023.

(30) Foreign Application Priority Data
Mar. 7, 2022 (JP) 2022-034287

(51) Int. Cl. C03C 3/21; C03C 3/068; C03C 3/19

(52) U.S. Cl. CPC C03C 3/21; C03C 3/068; C03C 3/19

(57) ABSTRACT

Provided is a glass having a high refractive index and capable of suppressing a decrease in transmittance with respect to visible light. A glass (10) has a refractive index of 1.94 or more, an internal transmittance of 70% or more with respect to light having a wavelength of 440 nm at a plate thickness of 10 mm, and a degradation degree (ΔT) of 2.2% or less in an ultraviolet irradiation test.

### CROSS-REFERENCE TO RELATED APPLICATION(S)

This application is a continuation of International Application No. PCT/JP2023/007751, filed on Mar. 2, 2023 which claims the benefit of priority of the prior Japanese Patent Application No. 2022-034287, filed on Mar. 7, 2022, the entire contents of which are incorporated herein by reference.

### BACKGROUND OF THE INVENTION

### 1. Field of the Invention

The present invention relates to glass.

### 2. Description of the Related Art

In recent years, a glass having a high refractive index has been required. In particular, for example, in a wearable device such as a head mounted display that implements augmented reality (AR), virtual reality (VR), mixed reality (MR), and the like as disclosed in WO 2020/090051 A, a high refractive index with respect to visible light is required as a light guide plate.

A transmittance of a glass with respect to visible light may be decreased by various factors such as coloring caused by an increase in a high refractive index component, mixing of impurities, and temporal change. Therefore, a glass is required to have a high refractive index and to suppress a decrease in transmittance with respect to visible light.

The present invention has been made in view of the above problem, and an object thereof is to provide a glass having a high refractive index and capable of suppressing a decrease in transmittance with respect to visible light.

The glass of the present disclosure has a refractive index of 1.94 or more, an internal transmittance of 70% or more with respect to light having a wavelength of 440 nm at a plate thickness of 10 mm, and a degradation degree ΔT of 2.2% or less in an ultraviolet irradiation test, wherein the degradation degree ΔT in the ultraviolet irradiation test is obtained by formula (1) below.

$$Δ T ( \% ) = \{ ( {T}_{0} - {T}_{1} ) / {T}_{0} \} \cdot 100 \qquad ( 1 )$$

The transmittance T₁ is an external transmittance of the glass with respect to light having a wavelength of 470 nm after a surface of the glass having a thickness of 1 mm is irradiated with ultraviolet rays having a wavelength of 365 nm at a UV illuminance of 50 mW/cm² for ten minutes, and the transmittance T₀ is an external transmittance of the glass at a wavelength of 470 nm before the irradiation with ultraviolet rays.

The present invention can provide a glass having a high refractive index and capable of suppressing a decrease in transmittance with respect to visible light.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a glass according to the present embodiment; and

FIG. 2 is a cross-sectional view when the glass according to the present embodiment is a glass plate.

### DETAILED DESCRIPTION OF THE PREFERRED EMBODIMENTS

Hereinafter, a preferred embodiment of the present invention will be described in detail with reference to the attached drawings. Note that the present invention is not limited by the embodiment, and when there is a plurality of embodiments, the present invention includes a combination of the embodiments. A numerical value includes a range of rounding.

### Glass

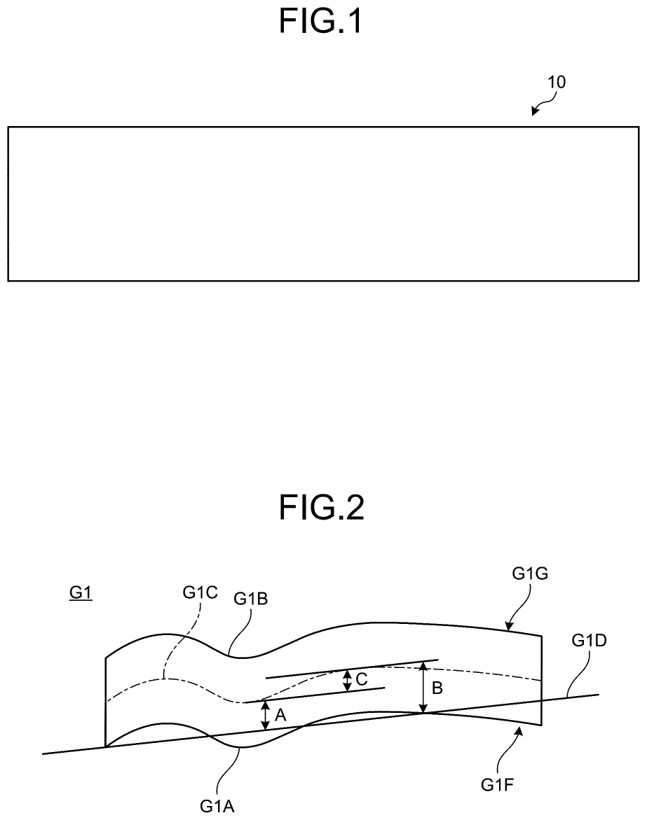

FIG. 1 is a schematic diagram of a glass according to the present embodiment. As illustrated in FIG. 1, a glass 10 according to the present embodiment is a plate-like glass plate, but the shape of the glass 10 is not limited to the plate shape and may be any shape. In the present embodiment, the glass 10 is used as a light guide plate. More specifically, the glass 10 is used as a light guide plate for a head mounted display. The head mounted display is a display device (wearable device) worn on a human head. Note that the glass 10 may be used for any use, and is not limited to being used as a light guide plate, and is not limited to being used for a head mounted display.

### Glass Composition

Hereinafter, the composition of the glass 10 will be described.

### TeO₂

TeO₂ is a component that contributes to increasing a refractive index while promoting vitrification. On the other hand, when TeO₂ is contained in a large amount, mechanical properties of glass are deteriorated. Therefore, in the glass 10, the content of TeO₂ is preferably 0.1% or more and less than 40.0%, more preferably 0.5% or more and 35.0% or less, more preferably 1.0% or more and 33.0% or less, more preferably 2.0% or more and 30.0% or less, more preferably 5.0% or more and 27.0% or less, more preferably 8.0% or more and 26.0% or less, more preferably 10.0% or more and 25.6% or less, more preferably 12.0% or more and 25.5% or less, and still more preferably 18.0% or more in terms of oxide-based mol %. When the content of TeO₂ is within this range, the glass 10 can have a high refractive index and can suppress a decrease in transmittance with respect to visible light.

Note that the content here refers to mol % of the content of an oxide when mol % of the total amount of the glass 10 is 100% in terms of oxide-based mol %. That is, for example, “the content of TeO₂ is more than 10.1%” means that TeO₂ is contained in an amount of more than 10.1% when mol % of the total amount of the glass 10 is 100% in terms of oxide-based mol %. An upper limit and a lower limit of the numerical range can be appropriately combined, and the same applies below.

P₂O₅

P₂O₅ is a glass-forming component and stabilizes glass. On the other hand, when P₂O₅ is contained in an excessively large amount, a refractive index decreases. Therefore, in the glass 10, the content of P₂O₅ is preferably 0% or more and 30.0% or less, more preferably 0.1% or more and 27% or less, more preferably 1.0% or more and 24% or less, more preferably 2.0% or more and 23% or less, more preferably 3.0% or more and 17% or less, more preferably 4.0% or more and 12% or less, more preferably 5.0% or more and 9.7% or less, more preferably 9.6% or less, and still more preferably 9.5% or less in terms of oxide-based mol %. When the content of P₂O₅ is within this range, the glass 10 can have a high refractive index and can suppress a decrease in transmittance with respect to visible light. Note that the glass 10 does not have to contain P₂O₅.

B₂O₃

B₂O₃ is a glass-forming component that contributes to improvement of stability of glass and improves manufacturing characteristics, but when B₂O₃ is contained in a large amount, a refractive index tends to decrease. Therefore, in the glass 10, the content of B₂O₃ is preferably 0% or more and 40% or less, more preferably 5.0% or more and 35.0% or less, more preferably 10.0% or more and 29.0% or less, more preferably 15.0% or more and 25.0% or less, and still more preferably 20.0% or more and 22.0% or less in terms of oxide-based mol %. When the content of B₂O₃ is within this range, the glass 10 can have a high refractive index and can suppress a decrease in transmittance with respect to visible light. Note that the glass 10 does not have to contain B₂O₃.

### Li₂O

Li₂O is a component capable of improving mechanical properties of a glass. On the other hand, when Li₂O is contained in an excessively large amount, a glass easily loses transparency, and manufacturing characteristics deteriorate. Therefore, in the glass 10, the content of Li₂O is preferably 0% or more and 15.0% or less, more preferably 0.10% or more and 10.0% or less, more preferably 0.50% or more and 8.0% or less, and still more preferably 1.0% or more and 4.0% or less in terms of oxide-based mol %. When the content of Li₂O is within this range, the glass 10 can have a high refractive index and can suppress a decrease in transmittance with respect to visible light. Note that the glass 10 does not have to contain Li₂O.

### Na₂O

In the glass 10, the content of Na₂O is preferably 0% or more and 15.0% or less, more preferably 0.10% or more and 10.0% or less, more preferably 0.50% or more and 5.0% or less, and more preferably 1.0% or more and 3.0% or less in terms of oxide-based mol %. It can be said that the content of Na₂O is also preferably 1.0% or less. When the content of Na₂O is within this range, the glass 10 can have a high refractive index and can suppress a decrease in transmittance with respect to visible light. Note that the glass 10 does not have to contain Na₂O.

### K₂O

In the glass 10, the content of K₂O is preferably 0% or more and 15.0% or less, more preferably 0.10% or more and 10.0% or less, more preferably 0.50% or more and 5.0% or less, and more preferably 1.0% or more and 3.0% or less in terms of oxide-based mol %. It can be said that the content of K₂O is also preferably 1.0% or less. When the content of K₂O is within this range, the glass 10 can have a high refractive index and can suppress a decrease in transmittance with respect to visible light. Note that the glass 10 does not have to contain K₂O.

### TiO₂

TiO₂ is a high refractive index component and suppresses a decrease in transmittance, but when TiO₂ is contained in a large amount, an internal transmittance of a glass is decreased. Therefore, in the glass 10, the content of TiO₂ is preferably 0% or more and 32.0% or less, more preferably 0.20% or more and 26.0% or less, more preferably 0.50% or more and 20.0% or less, more preferably 1.0% or more and 13.0% or less, and more preferably 2.0% or more and 10.0% or less in terms of oxide-based mol %. It can be said that the content of K₂O is also preferably 1.0% or more and 7.0% or less, and also preferably 2.0% or less. When the content of TiO₂ is within this range, the glass 10 can have a high refractive index and can suppress a decrease in transmittance with respect to visible light. Note that the glass 10 does not have to contain TiO₂.

Ta₂O₅

Ta₂O₅ is a component capable of increasing a refractive index, but when Ta₂O₅ is contained in an excessively large amount, a glass easily loses transparency, and manufacturing characteristics deteriorate. Therefore, in the glass 10, the content of Ta₂O₅ is preferably 0% or more and 20.0% or less, more preferably 0.1% or more and 10.0% or less, more preferably 0.5% or more and 5.0% or less, and still more preferably 1.00% or more and 2.0% or less in terms of oxide-based mol %. When the content of Ta₂O₅ is within this range, the glass 10 can have a high refractive index and can suppress a decrease in transmittance with respect to visible light. Note that the glass 10 does not have to contain Ta₂O₅.

### WO₃

WO₃ is a component capable of increasing a refractive index of a glass, but when WO₃ is contained in an excessively large amount, an internal transmittance decreases. Therefore, in the glass 10, the content of WO₃ is preferably 0% or more and 15.0% or less, more preferably 0.10% or more and 10.0% or less, more preferably 0.50% or more and 5.0% or less, and more preferably 1.0% or more and 2.0% or less in terms of oxide-based mol %. The content of WO₃ is also preferably 0.4% or less. When the content of WO₃ is within this range, the glass 10 can have a high refractive index and can suppress a decrease in transmittance with respect to visible light. Note that the glass 10 does not have to contain WO₃.

Nb₂O₅

Nb₂O₅ is a component that increases a refractive index of a glass and is a component that improves mechanical properties. However, when Nb₂O₅ is contained in a large amount, a glass easily loses transparency, and manufacturing characteristics deteriorate. Therefore, in the glass 10, the content of Nb₂O₅ is preferably 0% or more and less than 15.0%, more preferably 0.10% or more and 12.0% or less, more preferably 0.50% or more and 10.0% or less, more preferably 1.0% or more and 8.0% or less, more preferably 2.0% or more and 7.0% or less, and still more preferably 3.0% or more and 6.5% or less in terms of oxide-based mol %. When the content of Nb₂O₅ is within this range, the glass 10 can have a high refractive index and can suppress a decrease in transmittance with respect to visible light. Note that the glass 10 does not have to contain Nb₂O₅.

### ZrO₂

ZrO₂ is a component capable of improving mechanical properties while improving a refractive index. However, when ZrO₂ is contained in an excessively large amount, a glass easily loses transparency, and manufacturing characteristics deteriorate. Therefore, in the glass 10, it can be said that the content of ZrO₂ is preferably 0% or more and 20% or less, more preferably 0.10% or more and 15.0% or less, more preferably 0.50% or more and 10.0% or less, more preferably 1.0% or more and 9.0% or less, more preferably 2.0% or more and 8.0% or less, more preferably 3.0% or more and 6.0% or less, and still more preferably 5.0% or less in terms of oxide-based mol %. When the content of ZrO₂ is within this range, the glass 10 can have a high refractive index and can suppress a decrease in transmittance with respect to visible light. Note that the glass 10 does not have to contain ZrO₂.

Bi₂O₃

Bi₂O₃ is a component that can largely improve a refractive index. However, when Bi₂O₃ is contained in a large amount, Bi₂O₃ not only deteriorate manufacturing characteristics but also decreases a transmittance. Therefore, in the glass 10, the content of Bi₂O₃ is preferably more than 15% and 45% or less, more preferably 20% or more and 40% or less, more preferably 24% or more and 38% or less, more preferably 28% or more and 36.0% or less, more preferably 30.0% or more and 34.0% or less, more preferably 30.0% or more and 33.0% or less, more preferably 30.0% or more and 32.0% or less, and still more preferably 30.0% or more and 31.0% or less in terms of oxide-based mol %. When the content of Bi₂O₃ is within this range, the glass 10 can have a high refractive index and can suppress a decrease in transmittance with respect to visible light. Note that the glass 10 does not have to contain Bi₂O₃.

### ZnO

In the glass 10, the content of ZnO is preferably 0% or more and 20% or less, more preferably 0.5% or more and 15% or less, more preferably 1.0% or more and 10% or less, more preferably 1.5% or more and 8.0% or less, more preferably 2.0% or more and 6.0% or less, more preferably 3.0% or more and 5.4% or less, and still more preferably 4.0% or more and 5.3% or less in terms of oxide-based mol %. When the content of ZnO is within this range, the glass 10 can have a high refractive index and can suppress a decrease in transmittance with respect to visible light. Note that the glass 10 does not have to contain ZnO.

### SrO

In the glass 10, the content of SrO is preferably 0% or more and 20% or less, more preferably 0.5% or more and 15% or less, more preferably 1.0% or more and 10% or less, more preferably 1.5% or more and 8.0% or less, and more preferably 2.0% or more and 5.0% or less in terms of oxide-based mol %. The content of SrO is also preferably 2.0% or less. When the content of SrO is within this range, the glass 10 can have a high refractive index and can suppress a decrease in transmittance with respect to visible light. Note that the glass 10 does not have to contain SrO.

La₂O₃

In the glass 10, the content of La₂O₃ is preferably 0% or more and 30% or less, more preferably 0.5% or more and 20% or less, more preferably 1.0% or more and 15% or less, more preferably 1.5% or more and 10% or less, and more preferably 2.0% or more and 5.0% or less in terms of oxide-based mol %. The content of La₂O₃ is also preferably 2.0% or less. When the content of La₂O₃ is within this range, the glass 10 can have a high refractive index and can suppress a decrease in transmittance with respect to visible light. Note that the glass 10 does not have to contain La₂O₃.

### SiO₂

In the glass 10, the content of SiO₂ is preferably 0% or more and 30% or less, more preferably 0.5% or more and 20% or less, more preferably 1.0% or more and 15% or less, more preferably 1.5% or more and 10% or less, more preferably 2.0% or more and 9.0% or less, more preferably 3.0% or more and 9.0% or less, more preferably 4.0% or more and 8.0% or less, and still more preferably 8.0% or less in terms of oxide-based mol %. When the content of SiO₂ is within this range, the glass 10 can have a high refractive index and can suppress a decrease in transmittance with respect to visible light. Note that the glass 10 does not have to contain SiO₂.

P₂O₅+TeO₂+B₂O₃+TiO₂+Ta₂O₅+WO₃+ZrO₂+Bi₂O₃+ZnO

In the glass 10, the content of (P₂O₅+TeO₂+B₂O₃+TiO₂+Ta₂O₅+WO₃+ZrO₂+Bi₂O₃+ZnO), that is, the total content of P₂O₅, TeO₂, B₂O₃, TiO₂, Ta₂O₅, WO₃, ZrO₂, Bi₂O₃, and ZnO is preferably 70% or more, more preferably 73% or more and 99.5% or less, more preferably 75% or more and 98.0% or less, more preferably 78% or more and 97.0% or less, more preferably 85% or more and 96.0% or less, more preferably 90% or more and 95.0% or less, and still more preferably 92% or more and 94.0% or less in terms of oxide-based molar ratio. When the total content of these components is within this range, the glass 10 can have a high refractive index and can suppress a decrease in transmittance with respect to visible light. Note that the glass 10 does not have to contain at least one of these components.

### Parameter A

A parameter A of the glass 10 will be described. The parameter A is a parameter related to a Young's modulus calculated from the composition of the glass 10. For example, a degradation degree in an ultraviolet irradiation test tends to increase as a value of the parameter A increases. The parameter A is calculated as in the following formula (A).

A=c(P₂O₅)²+c(Nb₂O₅)²−c(TiO₂)² (A)

Here, c in formula (A) is the content (%) of an oxide described in parentheses with respect to the entire glass 10 in terms of oxide-based mol %. That is,
c(P₂O₅) is the content (%) of P₂O₅ in terms of oxide-based mol %,
c(Nb₂O₅) is the content (%) of Nb₂O₅ in terms of oxide-based mol %, and
c(TiO₂) is the content (%) of TiO₂ in terms of oxide-based mol %.

The parameter A of the glass 10 is preferably 270 or less, more preferably −20 or more and 200 or less, more preferably −10 or more and 170 or less, more preferably −7 or more and 150 or less, more preferably −5 or more and 140 or less, more preferably −4 or more and 130 or less, and still more preferably −3 or more and 120 or less. When the parameter A is within this range, the degradation degree can be kept low, and a possibility of a decrease in transmittance can be suppressed.

Note that the glass 10 may contain an oxide other than those listed in formula (A), but the content of the oxide other than those listed in formula (A) is not used for the calculation of the parameter A. That is, it can be said that the value of the parameter A does not change depending on presence or absence of an oxide other than those listed in formula (A).

The glass 10 is not limited to those containing all the oxides listed in formula (A). In this case, a value on the right side of formula (A) for an oxide listed in formula (2) but not contained in the glass 10 is 0. That is, for example, when P₂O₅ is not included in the glass 10, the parameter A is calculated with c(P₂O₅) in formula (A) as 0.

### Parameter B

A parameter B of the glass 10 will be described. The parameter B is a parameter related to a degradation degree in an ultraviolet irradiation test, calculated from the composition of the glass 10. For example, the degradation degree in the ultraviolet irradiation test tends to increase as a value of the parameter B increases. The parameter B is calculated as in the following formula (B).

B=0.13455·2.7183^{(0.014912·A)} (B)

Here, A in formula (B) is the parameter A.

The parameter B of the glass 10 is preferably 2.5 or less, more preferably 2.3 or less, more preferably 1.8 or less, more preferably 1.5 or less, more preferably 1.3 or less, more preferably 1.1 or less, more preferably 1.0 or less, more preferably 0.8 or less, more preferably 0.7 or less, more preferably 0.6 or less, and still more preferably 0.5 or less. When the parameter B is within this range, the degradation degree can be kept low, and a possibility of a decrease in transmittance can be suppressed.

### Content of Fe, Cr, and Ni

In the glass 10, the total content of Fe, Cr, and Ni is preferably less than 4 ppm, more preferably 3 ppm or less, more preferably 2 ppm or less, more preferably 1 ppm or less, more preferably 0.7 ppm or less, more preferably 0.5 ppm or less, more preferably 0.3 ppm or less, and still more preferably 0.1 ppm or less with respect to the entire glass 10 in terms of a mass ratio. Fe, Cr, and Ni here do not refer to only elemental metals of Fe, Cr, and Ni contained in the glass 10, and may include elemental metals and compounds of Fe, Cr, and Ni. That is, the total content of Fe, Cr, and Ni can be said to include the contents of elemental metals of Fe, Cr, and Ni and the contents of ions of Fe, Cr, and Ni in compounds. When the total content of Fe, Cr, and Ni, which are coloring transition metals, is within this range, a decrease in transmittance of the glass 10 with respect to visible light can be suppressed, and the glass 10 can have a high transmittance with respect to visible light. The total content of Fe, Cr, and Ni can be measured by ICP mass spectrometry. As a measuring instrument, for example, Agilent 8800 manufactured by Agilent Technologies can be used.

In the glass 10, the total content of Fe, Cr, Ni, Cu, Mn, Co, and V is preferably less than 4 ppm, more preferably 3 ppm or less, more preferably 2 ppm or less, and still more preferably 1 ppm or less with respect to the entire glass 10 in terms of a mass ratio. Similarly to Fe, Cr, and Ni described above, Fe, Cr, Ni, Cu, Mn, Co, and V here do not refer to only elemental metals of Fe, Cr, Ni, Cu, Mn, Co, and V contained in the glass 10, and may include elemental metals and compounds of Fe, Cr, Ni, Cu, Mn, Co, and V. That is, the total content of Fe, Cr, Ni, Cu, Mn, Co, and V can be said to include the contents of elemental metals of Fe, Cr, Ni, Cu, Mn, Co, and V and the contents of ions of Fe, Cr, Ni, Cu, Mn, Co, and V in compounds. When the total content of Fe, Cr, Ni, Cu, Mn, Co, and V, which are coloring transition metals, is within this range, a decrease in transmittance of the glass 10 with respect to visible light can be suppressed, and the glass 10 can have a high transmittance with respect to visible light. The total content of the above components can be measured by ICP mass spectrometry.

### Content of Pb

In the glass 10, the total content of Pb is preferably less than 1000 ppm, more preferably 100 ppm or less, and still more preferably 10 ppm or less with respect to the entire glass 10 in terms of a mass ratio. That is, preferably, the glass 10 does not substantially contain Pb. Similarly to Fe, Cr, and Ni described above, Pb here does not refer to only an elemental metal of Pb contained in the glass 10, and may include an elemental metal and a compound of Pb. That is, it can be said that the content of Pb includes the content of an elemental metal of Pb and the content of ions of Pb in a compound. The content of Pb can be measured by ICP mass spectrometry.

The glass 10 preferably contains boric acid or phosphoric acid. That is, the glass 10 is preferably borate glass, phosphate glass, or fluorophosphate glass.

### Characteristics of Glass

Next, characteristics of the glass 10 will be described.

### Refractive Index n_{d}

A refractive index n_{d} of the glass 10 is 1.94 or more, more preferably 1.95 or more, more preferably 1.97 or more, more preferably 1.99 or more, more preferably 2.01 or more, more preferably 2.03 or more, more preferably 2.05 or more, more preferably 2.06 or more, more preferably 2.07 or more, more preferably 2.08 or more, and still more preferably 2.09 or more. When the refractive index n_{d} is within this range, a high refractive index with respect to visible light can be achieved. The refractive index n_{d} of the glass 10 is preferably 2.20 or less, more preferably 2.17 or less, more preferably 2.15 or less, and still more preferably 2.13 or less. That is, it can be said that the refractive index n_{d} of the glass 10 is preferably 1.94 or more and 2.20 or less, more preferably 1.95 or more and 2.17 or less, more preferably 1.97 or more and 2.15 or less, more preferably 1.99 or more and 2.13 or less, more preferably 2.01 or more and 2.13 or less, more preferably 2.03 or more and 2.13 or less, more preferably 2.05 or more and 2.13 or less, more preferably 2.06 or more and 2.13 or less, more preferably 2.07 or more and 2.13 or less, more preferably 2.08 or more and 2.13 or less, and still more preferably 2.09 or more and 2.13 or less.

Note that the refractive index n_{d} refers to a refractive index at a d-line (wavelength 587.6 nm) of helium. The refractive index n_{d} can be measured by a V block method.

### Degradation Degree ΔT

In the glass 10, a degradation degree ΔT in an ultraviolet irradiation test is 2.2% or less, preferably 1.8% or less, more preferably 1.5% or less, more preferably 1.4% or less, more preferably 1.3% or less, more preferably 1.2% or less, more preferably 1.0% or less, more preferably 0.9% or less, more preferably 0.8% or less, more preferably 0.7% or less, and still more preferably 0.5% or less. When the degradation degree ΔT is within this range, a decrease in transmittance can be suppressed even in a case of irradiation with ultraviolet rays, and a decrease in transmittance with respect to visible light can be suppressed.

Here, the degradation degree in the ultraviolet irradiation test is obtained by the following formula (1).

$$Δ T ( \% ) = \{ ( {T}_{0} - {T}_{1} ) / {T}_{0} \} \cdot 100 \qquad ( 1 )$$

The transmittance T₁ in formula (1) refers to an external transmittance of the glass 10 with respect to light having a wavelength of 470 nm after a surface of the glass 10 having a thickness of 1 mm is irradiated with ultraviolet rays having a wavelength of 365 nm at a UV illuminance of 50 mW/cm² for ten minutes. More specifically, the surface of the glass 10 is irradiated with ultraviolet rays having a wavelength of 365 nm for ten minutes from a UV-LED irradiation device (LSS-24 manufactured by Sun Energy Corporation) in which a UV illuminance of the glass surface is adjusted to 50 mW/cm² using an ultraviolet integrated photometer (UIT-250 manufactured by USHIO INC.). The external transmittance with respect to light having a wavelength of 470 nm is measured for the glass 10 after being irradiated with ultraviolet rays in this manner using a spectrophotometer (U-4100 manufactured by Hitachi High-Technologies Corporation), and the measured value is defined as the transmittance T₁. On the other hand, the transmittance T₀ in formula (1) is a transmittance of the glass 10 at a wavelength of 470 nm before irradiation with ultraviolet rays. That is, the external transmittance with respect to light having a wavelength of 470 nm is measured in advance also for the glass 10 before being irradiated with ultraviolet rays using a spectrophotometer (U-4100 manufactured by Hitachi High-Technologies Corporation) as described above, and the measured value is defined as the transmittance T₀.

### Young's Modulus

A Young's modulus of the glass 10 is preferably 60 GPa or more and less than 100 GPa, more preferably 62 GPa or more and 95 GPa or less, and still more preferably 65 GPa or more and 90 GPa or less. By having such a high Young's modulus, the glass 10 can appropriately suppress breakage of the glass 10. Note that the Young's modulus can be measured on the basis of propagation of an ultrasonic wave using 38DL PLUS manufactured by OLYMPUS Corporation.

### Wavelength λ₇₀

Here, a wavelength indicating an internal transmittance of 70% at a plate thickness (thickness) of 10 mm is defined as a wavelength λ₇₀. That is, the wavelength λ₇₀ refers to a wavelength of light at which the internal transmittance is 70% for a sample having a thickness of 10 mm. The wavelength λ₇₀ of the glass 10 at a plate thickness (thickness) of 10 mm is preferably 455 nm or less, more preferably 445 nm or less, more preferably 435 nm or less, more preferably 430 nm or less, more preferably 425 nm or less, and still more preferably 420 nm or less. In addition, the wavelength λ₇₀ of the glass 10 is preferably 390 nm or more, more preferably 395 nm or more, and still more preferably 400 nm or more.

That is, it can be said that the wavelength Δ₇₀ of the glass 10 is preferably 390 nm or more and 455 nm or less, more preferably 395 nm or more and 445 nm or less, more preferably 400 nm or more and 435 nm or less, more preferably 400 nm or more and 430 nm or less, more preferably 400 nm or more and 425 nm or less, and still more preferably 400 nm or more and 420 nm or less.

When wavelength λ₇₀ is within this range, a high transmittance with respect to visible light can be achieved. Note that the internal transmittance for calculating the wavelength λ₇₀ can be obtained from measured values of two types of external transmittances having different plate thicknesses and the following formula (2). Note that the external transmittance means a transmittance including a surface reflection loss. In formula (2), X is an internal transmittance of a glass having a thickness of 10 mm, T1 and T2 are external transmittances, and Δd is a difference in thickness between samples. The external transmittance can be measured using a spectrophotometer (U-4100 manufactured by Hitachi High-Technologies Corporation) for a sample whose both surfaces have been mirror-polished so as to have a plate thickness of 10 mm.

$$log X = - \frac{log T 1 - log T 2}{Δ d} \times 10 \qquad ( 2 )$$

### Transmittance of Light

In the glass 10, an internal transmittance with respect to light having a wavelength of 440 nm at a plate thickness (thickness) of 10 mm is preferably 70% or more, more preferably 75% or more, more preferably 78% or more, more preferably 81% or more, more preferably 84% or more, more preferably 87% or more, more preferably 89% or more, more preferably 90% or more, more preferably 91% or more, and still more preferably 92% or more.

When the internal transmittance with respect to light having a wavelength of 440 nm is within this range, a high transmittance with respect to visible light can be achieved. The internal transmittance of a glass having a thickness of 10 mm can be obtained from measured values of two types of external transmittances having different plate thicknesses and formula (2).

### Form of Glass

The glass 10 according to the present embodiment is preferably an optical glass, and is preferably a glass plate having a thickness of 0.01 mm or more and 2.0 mm or less. When the thickness is 0.01 mm or more, breakage of the glass 10 during handling or processing can be suppressed. In addition, deflection of the glass 10 due to its own weight can be suppressed. This thickness is more preferably 0.1 mm or more, still more preferably 0.2 mm or more, and further still more preferably 0.3 mm or more. On the other hand, when the thickness is 2.0 mm or less, an optical element using the glass 10 can be made lightweight. This thickness is more preferably 1.5 mm or less, still more preferably 1.0 mm or less, and further still more preferably 0.8 mm or less.

When the glass 10 according to the present embodiment is a glass plate, the area of a main surface is preferably 8 cm² or more. When this area is 8 cm² or more, a large number of optical elements can be arranged, and productivity is improved. This area is more preferably 30 cm² or more, still more preferably 170 cm² or more, further still more preferably 300 cm² or more, and particularly preferably 1000 cm² or more. On the other hand, when the area is 6500 cm² or less, handling of the glass plate is easy, and breakage during handling or processing of the glass plate can be suppressed. This area is more preferably 4500 cm² or less, still more preferably 4000 cm² or less, further still more preferably 3000 cm² or less, and particularly preferably 2000 cm² or less.

When the glass 10 according to the present embodiment is a glass plate, local thickness variation (LTV) at 25 cm² of a main surface is preferably 2 μm or less. By having a flatness in this range, a nanostructure having a desired shape can be formed on the main surface using an imprinting technique or the like, and desired light guiding characteristics can be obtained. In particular, in a light guide body, a ghost phenomenon and distortion due to a difference in optical path length can be prevented. This LTV is more preferably 1.5 μm or less, still more preferably 1.0 μm or less, and particularly preferably 0.5 μm or less.

When the glass 10 according to the present embodiment is a circular glass plate having a diameter of 8 inches, the glass 10 preferably has a warpage of 50 μm or less. When the warpage of the glass 10 is 50 μm or less, a nanostructure having a desired shape can be formed on the main surface using an imprinting technique or the like, and desired light guiding characteristics can be obtained. When a plurality of light guide bodies are to be obtained, light guide bodies having stable quality can be obtained. The warpage of the glass 10 is more preferably 40 μm or less, still more preferably 30 μm or less, and particularly preferably 20 μm or less.

When the glass 10 according to the present embodiment is a circular glass plate having a diameter of 6 inches, the glass 10 preferably has a warpage of 30 μm or less. When the warpage of the glass 10 is 30 μm or less, a nanostructure having a desired shape can be formed on the main surface using an imprinting technique or the like, and desired light guiding characteristics can be obtained. When a plurality of light guide bodies are to be obtained, light guide bodies having stable quality can be obtained. The warpage of the glass 10 is more preferably 20 μm or less, still more preferably 15 μm or less, and particularly preferably 10 μm or less.

When the glass 10 according to the present embodiment is a square glass plate having each side of 6 inches, the glass 10 preferably has a warpage of 100 μm or less. When the warpage of the glass 10 is 100 μm or less, a nanostructure having a desired shape can be formed on the main surface using an imprinting technique or the like, and desired light guiding characteristics can be obtained. When a plurality of light guide bodies are to be obtained, light guide bodies having stable quality can be obtained. The warpage of the glass 10 is more preferably 70 μm or less, still more preferably 50 μm or less, further still more preferably 35 μm or less, and particularly preferably 20 μm or less.

FIG. 2 is a cross-sectional view when the glass according to the present embodiment is a glass plate. The “warpage” is a difference C between a maximum value B and a minimum value A of a distance in a vertical direction between a reference line G1D of a glass plate G1 and a center line G1C of the glass plate G1 in any cross section passing through a center of a main surface G1F of the glass plate G1 and orthogonal to the main surface G1F of the glass plate G1, in which the glass plate G1 is the glass 10 according to the present embodiment.

An intersection line between the any orthogonal cross section and the main surface G1F of the glass plate G1 is defined as a bottom line G1A. An intersection line between the any orthogonal cross section and the other main surface G1G of the glass plate G1 is defined as an upper line G1B. Here, the center line G1C is a line connecting centers of the glass plate G1 in a plate thickness direction. The center line G1C is calculated by obtaining a midpoint between the bottom line G1A and the upper line G1B in a laser irradiation direction described later.

The reference line G1D is obtained as follows. First, the bottom line G1A is calculated under a measurement method for canceling an influence of the own weight of the glass plate G1. A straight line is obtained from the bottom line G1A by a least square method. The obtained straight line is the reference line G1D. As a measurement method for canceling an influence of the own weight of the glass plate G1, a known method is used.

For example, the main surface G1F of the glass plate G1 is supported at three points, the glass plate G1 is irradiated with a laser by a laser displacement meter, and the heights of the main surface G1F and the other main surface G1G of the glass plate G1 from any reference surface are measured.

Next, the glass plate G1 is inverted, three points of the other main surface G1G opposite to the three points supporting the one main surface G1F are supported, and the heights of the main surface G1F and the other main surface G1G of the glass plate G1 from any reference surface are measured.

An influence of the own weight of the glass plate G1 is canceled by obtaining an average of the heights of the measurement points before and after the inversion. For example, before the inversion, as described above, the height of the main surface G1F is measured. After the inversion of the glass plate G1, the height of the other main surface G1G is measured at a position corresponding to the measurement point of the main surface G1F. Similarly, before the inversion, the height of the other main surface G1G is measured. After the inversion of the glass plate G1, the height of the main surface G1F is measured at a position corresponding to the measurement point of the other main surface G1G.

The warpage is measured by, for example, a laser displacement meter.

In the glass 10 according to the present embodiment, a surface roughness Ra of the main surface is preferably 2 nm or less. By having Ra in this range, a nanostructure having a desired shape can be formed on the main surface using an imprinting technique or the like, and desired light guiding characteristics can be obtained. In particular, in a light guide body, irregular reflection at an interface is suppressed, and a ghost phenomenon and distortion can be prevented. Ra is more preferably 1.7 nm or less, still more preferably 1.4 nm or less, still more preferably 1.2 nm or less, and particularly preferably 1 nm or less. Here, the surface roughness Ra is an arithmetic average roughness defined in JIS B0601 (2001). In the present specification, the surface roughness Ra is a value obtained by measuring an area of 10 μm×10 μm using an atomic force microscope (AFM).

### Method for Manufacturing Glass

A method for manufacturing the glass 10 according to the present embodiment is not particularly limited, and for example, existing plate glass manufacturing methods such as a float method, a fusion method, and a roll-out method can be used. In addition to these methods, a known method such as slicing a cast glass lump and cutting out a glass plate can be used. Note that, in order to suppress deterioration of a transmittance due to mixing of impurities, the glass 10 preferably uses Au and an Au alloy as a material of a container (crucible) in which a raw material is put when the raw material is melted.

Furthermore, the glass 10 of the present embodiment is preferably subjected to an operation of increasing a moisture content in molten glass in a melting step of heating and melting a glass raw material in a melting container to obtain molten glass. The operation of increasing the moisture content in the glass is not limited, but for example, a treatment of adding water vapor to a molten atmosphere and a treatment of bubbling a gas containing water vapor into a melt can be considered. The operation of increasing the moisture content is not essential, but can be performed for the purpose of improving a transmittance, improving clarity, and the like.

The glass 10 of the present embodiment containing an alkali metal oxide of Li₂O or Na₂O can be chemically strengthened by replacing a Li ion with a Na ion or a K ion and replacing a Na ion with a K ion. That is, when the chemical strengthening treatment is performed, strength of optical glass can be improved.

### Effect

As described above, the glass 10 according to the present embodiment has a refractive index of 1.94 or more, an internal transmittance of 70% or more with respect to light having a wavelength of 440 nm at a plate thickness of 10 mm, and a degradation degree (ΔT) of 2.2% or less in an ultraviolet irradiation test.

Here, there is a case where a glass having a high refractive index is required. Regarding this, the glass 10 according to the present embodiment can achieve a high refractive index by having a refractive index of 1.94 or more. In addition, a transmittance of glass with respect to visible light may decrease. For example, glass may be colored when being irradiated with ultraviolet rays, and a transmittance thereof may decrease, that is, so-called solarization may occur. On the other hand, the glass 10 according to the present embodiment can suppress a decrease in transmittance even when being irradiated with ultraviolet rays by setting the degradation degree ΔT in the ultraviolet irradiation test within the above range. In addition, by setting the internal transmittance within the above range, the transmittance can be kept high. As described above, according to the present embodiment, it is possible to suppress a decrease in transmittance with respect to visible light while making the refractive index of the glass 10 high.

In the glass 10 according to the present embodiment, the content of Nb₂O₅ is preferably 0% or more and less than 15% in terms of oxide-based mol %. This makes it possible to suppress a decrease in transmittance with respect to visible light while making the refractive index of the glass 10 high.

In the glass 10 according to the present embodiment, preferably, the content of P₂O₅ is 0% or more and 30% or less and the content of TiO₂ is 0% or more and 30% or less in terms of oxide-based mol %. This makes it possible to suppress a decrease in transmittance with respect to visible light while making the refractive index of the glass 10 high.

The glass 10 according to the present embodiment preferably contains, in terms of oxide-based mol %,
P₂O₅: 0% or more and 30% or less,
TeO₂: 0.1% or more and less than 40%,
B₂O₃: 0% or more and 40% or less,
Li₂O: 0% or more and 15% or less,
Na₂O: 0% or more and 15% or less,
K₂O: 0% or more and 15% or less,
TiO₂: 0% or more and 30% or less,
Ta₂O₅: 0% or more and 20% or less,
WO₃: 0% or more and 15% or less,
Nb₂O₅: 0% or more and less than 15%,
ZrO₂: 0% or more and 20% or less,
Bi₂O₃: more than 15% and 45% or less
ZnO: 0% or more and 20% or less,
SrO: 0% or more and 20% or less,
La₂O₃: 0% or more and 30% or less, and
SiO₂: 0% or more and 30% or less. This makes it possible to suppress a decrease in transmittance with respect to visible light while making the refractive index of the glass 10 high.

In the glass 10 according to the present embodiment, the total content of Fe, Cr, and Ni is preferably less than 4 ppm in terms of a mass. This makes it possible to suppress a decrease in transmittance with respect to visible light while making the refractive index of the glass 10 high.

The glass 10 according to the present embodiment preferably has a thickness of 0.01 mm or more and 2.0 mm or less and a surface area of 8 cm² or more. According to the present embodiment, for the glass 10 having such a shape, it is possible to suppress a decrease in transmittance with respect to visible light while achieving a high refractive index.

The glass 10 according to the present embodiment is preferably used as a light guide plate. The glass 10 has a high refractive index and can improve resistance to ultraviolet rays, and thus is appropriately used as the light guide plate. In particular, since the light guide plate may be irradiated with ultraviolet rays in a manufacturing process, it is particularly preferable to use the glass 10 capable of improving resistance to ultraviolet rays.

### Working Examples

Next, Working Examples will be described. Note that the embodiment may be changed as long as the effect of the invention is obtained.

In Working Examples, glasses having different compositions were manufactured. Then, each of the glasses was evaluated. This will be described in more detail below.

Table 1-1 and Table 1-2 are Tables presenting glasses of Examples. Tables 1-1 and 1-2 present the contents of materials used for manufacturing glasses for Examples 1 to 32 in terms of oxide-based mol %. The total content of nine components is the total content of P₂O₅, TeO₂, B₂O₃, TiO₂, Ta₂O₅, WO₃, ZrO₂, Bi₂O₃, and ZnO in terms of oxide-based mol %. In addition, the parameters A and B refer to the values described in the above embodiment. Note that Examples 1 to 31 are Working Examples, and Example 32 is Comparative Example.

| | Composition (mol %) | | | | | | | | | | | | | | | | |
|---|---|---|---|---|---|---|---|---|---|---|---|---|---|---|---|---|---|
| | P₂O₅ | TeO₂ | B₂O₃ | Li₂O₃ | Na₂O | K₂O | TiO₂ | Ta₂O₅ | WO₃ | Nb₂O₅ | ZrO₂ | Bi₂O₃ | ZnO | SrO | La₂O₃ | SiO₂ | Total |
| Example 1 | 9.7 | 25.6 | 21.6 | 0.0 | 0.0 | 0.0 | 0.0 | 0.5 | 0.0 | 6.7 | 0.0 | 30.5 | 5.4 | 0.0 | 0.0 | 0.0 | 100 |
| Example 2 | 9.7 | 25.6 | 22.1 | 0.0 | 0.0 | 0.0 | 0.0 | 0.0 | 0.0 | 6.7 | 0.0 | 30.5 | 5.4 | 0.0 | 0.0 | 0.0 | 100 |
| Example 3 | 9.7 | 25.6 | 21.6 | 0.0 | 0.0 | 0.0 | 0.0 | 0.0 | 0.0 | 7.2 | 0.0 | 30.5 | 5.4 | 0.0 | 0.0 | 0.0 | 100 |
| Example 4 | 9.7 | 25.6 | 21.6 | 0.0 | 0.0 | 0.0 | 0.0 | 0.0 | 0.0 | 6.7 | 0.0 | 31.0 | 5.4 | 0.0 | 0.0 | 0.0 | 100 |
| Example 5 | 10.2 | 25.6 | 21.6 | 0.0 | 0.0 | 0.0 | 0.0 | 0.0 | 0.0 | 6.7 | 0.0 | 30.5 | 5.4 | 0.0 | 0.0 | 0.0 | 100 |
| Example 6 | 9.6 | 25.5 | 21.5 | 0.0 | 0.0 | 0.0 | 1.0 | 0.0 | 0.0 | 6.7 | 0.0 | 30.4 | 5.4 | 0.0 | 0.0 | 0.0 | 100 |
| Example 7 | 9.6 | 25.5 | 21.5 | 0.0 | 0.0 | 0.0 | 2.0 | 0.0 | 0.0 | 6.7 | 0.0 | 30.4 | 5.4 | 0.0 | 0.0 | 0.0 | 100 |
| Example 8 | 9.7 | 24.7 | 22.2 | 0.0 | 0.0 | 0.0 | 0.0 | 0.5 | 0.0 | 6.7 | 0.0 | 30.7 | 5.4 | 0.0 | 0.0 | 0.0 | 100 |
| Example 9 | 9.7 | 24.7 | 21.6 | 0.0 | 0.0 | 0.0 | 1.0 | 0.5 | 0.0 | 6.7 | 0.0 | 30.5 | 5.4 | 0.0 | 0.0 | 0.0 | 100 |
| Example 10 | 9.6 | 22.5 | 21.5 | 0.0 | 0.0 | 0.0 | 4.0 | 0.0 | 0.0 | 6.7 | 0.0 | 30.4 | 5.4 | 0.0 | 0.0 | 0.0 | 100 |
| Example 11 | 9.7 | 24.7 | 21.7 | 0.0 | 0.0 | 0.0 | 0.0 | 1.0 | 0.0 | 6.7 | 0.0 | 30.7 | 5.4 | 0.0 | 0.0 | 0.0 | 100 |
| Example 12 | 9.7 | 24.7 | 21.7 | 0.0 | 0.0 | 0.0 | 0.0 | 0.0 | 1.0 | 6.7 | 0.0 | 30.7 | 5.4 | 0.0 | 0.0 | 0.0 | 100 |
| Example 13 | 9.8 | 22.9 | 21.9 | 0.0 | 0.0 | 0.0 | 0.0 | 0.0 | 0.0 | 6.8 | 0.0 | 33.0 | 5.5 | 0.0 | 0.0 | 0.0 | 100 |
| Example 14 | 9.6 | 18.5 | 21.5 | 0.0 | 0.0 | 0.0 | 8.0 | 0.0 | 0.0 | 6.7 | 0.0 | 30.4 | 5.4 | 0.0 | 0.0 | 0.0 | 100 |
| Example 15 | 9.6 | 22.5 | 21.5 | 0.0 | 0.0 | 0.0 | 2.0 | 0.0 | 0.0 | 6.7 | 2.0 | 30.4 | 5.4 | 0.0 | 0.0 | 0.0 | 100 |
| Example 16 | 9.5 | 23.1 | 21.2 | 0.0 | 0.0 | 0.0 | 0.0 | 0.0 | 0.0 | 5.1 | 5.9 | 29.9 | 5.3 | 0.0 | 0.0 | 0.0 | 100 |
| Example 17 | 9.5 | 23.0 | 21.1 | 0.0 | 0.0 | 0.0 | 0.0 | 0.0 | 0.0 | 4.6 | 6.9 | 29.8 | 5.2 | 0.0 | 0.0 | 0.0 | 100 |
| Example 18 | 9.6 | 23.5 | 21.5 | 0.0 | 0.0 | 0.0 | 0.0 | 0.0 | 0.0 | 6.7 | 3.0 | 30.4 | 5.4 | 0.0 | 0.0 | 0.0 | 100 |
| Example 19 | 9.5 | 26.2 | 21.3 | 0.0 | 0.0 | 0.0 | 2.0 | 0.0 | 0.0 | 5.6 | 0.0 | 30.1 | 5.3 | 0.0 | 0.0 | 0.0 | 100 |
| Example 20 | 9.5 | 26.1 | 21.2 | 0.0 | 0.0 | 0.0 | 0.0 | 0.0 | 0.0 | 5.1 | 2.0 | 30.9 | 5.3 | 0.0 | 0.0 | 0.0 | 100 |
| Example 21 | 5.6 | 36.5 | 21.5 | 0.0 | 0.0 | 0.0 | 0.0 | 0.0 | 0.0 | 0.7 | 0.0 | 30.4 | 5.4 | 0.0 | 0.0 | 0.0 | 100 |
| Example 22 | 7.6 | 32.5 | 21.5 | 0.0 | 0.0 | 0.0 | 0.0 | 0.0 | 0.0 | 2.7 | 0.0 | 30.4 | 5.4 | 0.0 | 0.0 | 0.0 | 100 |
| Example 23 | 9.5 | 25.6 | 21.2 | 0.0 | 0.0 | 0.0 | 0.0 | 0.0 | 0.0 | 5.1 | 2.0 | 31.4 | 5.3 | 0.0 | 0.0 | 0.0 | 100 |
| Example 24 | 9.5 | 25.6 | 21.2 | 0.0 | 0.0 | 0.0 | 0.0 | 0.0 | 0.0 | 4.1 | 2.5 | 31.9 | 5.3 | 0.0 | 0.0 | 0.0 | 100 |
| Example 25 | 9.4 | 25.7 | 20.9 | 0.0 | 0.0 | 0.0 | 0.0 | 0.0 | 0.0 | 3.6 | 3.5 | 31.8 | 5.2 | 0.0 | 0.0 | 0.0 | 100 |
| Example 26 | 9.4 | 25.7 | 21.9 | 0.0 | 0.0 | 0.0 | 0.0 | 0.0 | 0.0 | 3.1 | 3.0 | 31.8 | 5.2 | 0.0 | 0.0 | 0.0 | 100 |
| Example 27 | 9.6 | 26.5 | 21.5 | 0.0 | 0.0 | 0.0 | 0.0 | 0.0 | 0.0 | 6.7 | 0.0 | 30.4 | 5.4 | 0.0 | 0.0 | 0.0 | 100 |
| Example 28 | 0.0 | 2.0 | 30.3 | 7.9 | 0.0 | 0.0 | 2.0 | 0.0 | 0.0 | 0.0 | 3.9 | 34.3 | 5.9 | 2.0 | 2.9 | 8.8 | 100 |
| Example 29 | 0.0 | 7.0 | 30.3 | 7.9 | 0.0 | 0.0 | 2.0 | 0.0 | 0.0 | 0.0 | 3.9 | 30.3 | 5.9 | 2.0 | 2.9 | 7.8 | 100 |
| Example 30 | 0.0 | 9.0 | 30.3 | 7.9 | 0.0 | 0.0 | 2.0 | 0.0 | 0.0 | 0.0 | 1.9 | 30.3 | 5.9 | 2.0 | 2.9 | 7.8 | 100 |
| Example 31 | 0.0 | 11.0 | 30.3 | 7.9 | 0.0 | 0.0 | 2.0 | 0.0 | 0.0 | 0.0 | 1.9 | 32.3 | 1.9 | 2.0 | 2.9 | 7.8 | 100 |
| Example 32 | 11.1 | 26.3 | 20.8 | 0.0 | 0.0 | 0.0 | 0.0 | 0.0 | 0.0 | 8.2 | 0.0 | 28.7 | 5.0 | 0.0 | 0.0 | 0.0 | 100 |

TABLE 1-2

| | Total | Degradation | | | Evaluation | | | |
|---|---|---|---|---|---|---|---|---|
| | content of | degree ΔT at | | | | | Internal | |
| | nine | wavelength of 470 | | | Young's | | transmittance | |
| | components | nm (1 mmt) after | Parameter | Parameter | modulus | Refractive | (%) at 440 | λ70 |
| | (mol %) | UV irradiation | A | B | (GPa) | index nd | nm | (nm) |
| Example 1 | 93.3 | 1.30 | 139 | 1.07 | 70.0 | 2.1024 | 92.4 | 416 |
| Example 2 | 93.3 | 1.18 | 139 | 1.07 | 70.5 | 2.0988 | 92.9 | 415 |
| Example 3 | 92.8 | 1.17 | 146 | 1.19 | 69.9 | 2.0881 | 90.5 | 416 |
| Example 4 | 93.3 | 1.24 | 139 | 1.07 | 69.9 | 2.1025 | 91.8 | 416 |
| Example 5 | 93.3 | 1.17 | 149 | 1.24 | 71.6 | 2.0964 | 93.2 | 415 |
| Example 6 | 93.3 | 1.00 | 137 | 1.03 | 71.4 | 2.1033 | 91.6 | 419 |
| Example 7 | 93.3 | 1.21 | 134 | 0.99 | 72.1 | 2.1062 | 90.0 | 422 |
| Example 8 | 93.3 | 1.11 | 140 | 1.09 | 71.3 | 2.0993 | 93.2 | 415 |
| Example 9 | 93.3 | 1.18 | 138 | 1.05 | 71.5 | 2.1037 | 91.2 | 420 |
| Example 10 | 93.3 | 0.89 | 122 | 0.82 | 73.1 | 2.1118 | 86.8 | 427 |
| Example 11 | 93.3 | 1.11 | 140 | 1.09 | 71.7 | 2.1027 | 92.5 | 416 |
| Example 12 | 93.3 | 0.96 | 140 | 1.09 | 70.9 | 2.1042 | 89.6 | 424 |
| Example 13 | 93.2 | 0.92 | 143 | 1.14 | 70.7 | 2.1123 | 91.9 | 418 |
| Example 14 | 93.3 | 0.14 | 74 | 0.40 | 76.6 | 2.1229 | 81.9 | 432 |
| Example 15 | 93.3 | 0.84 | 134 | 0.99 | 73.5 | 2.1054 | 90.1 | 422 |
| Example 16 | 94.9 | 0.77 | 116 | 0.76 | 72.2 | 2.0915 | 92.8 | 416 |
| Example 17 | 95.4 | 0.62 | 110 | 0.70 | 72.4 | 2.0890 | 92.7 | 416 |
| Example 18 | 93.3 | 1.20 | 138 | 1.05 | 72.5 | 2.0989 | 92.8 | 416 |
| Example 19 | 94.4 | 0.75 | 119 | 0.79 | 70.0 | 2.1015 | 90.0 | 422 |
| Example 20 | 94.9 | 0.73 | 116 | 0.76 | 69.4 | 2.0988 | 92.7 | 416 |
| Example 21 | 99.3 | 0.32 | 32 | 0.22 | 61.4 | 2.1151 | 91.6 | 419 |
| Example 22 | 97.3 | 0.44 | 66 | 0.36 | 64.6 | 2.1038 | 91.6 | 417 |
| Example 23 | 94.9 | 0.63 | 116 | 0.76 | 69.4 | 2.1015 | 92.3 | 416 |
| Example 24 | 95.9 | 0.73 | 107 | 0.66 | 68.9 | 2.1002 | 92.4 | 416 |
| Example 25 | 96.4 | 0.69 | 100 | 0.60 | 69.1 | 2.0995 | 92.6 | 416 |
| Example 26 | 96.9 | 0.68 | 97 | 0.57 | 68.2 | 2.0926 | 92.9 | 415 |
| Example 27 | 93.3 | 0.97 | 138 | 1.05 | 69.8 | 2.1010 | 93.0 | 416 |
| Example 28 | 78.4 | 0.05 | −4 | 0.13 | 78.0 | 2.0774 | 78.1 | 435 |
| Example 29 | 79.4 | 0.1 | −4 | 0.13 | 77.5 | 2.0558 | 83.7 | 431 |
| Example 30 | 79.4 | 0.12 | −4 | 0.13 | 75.8 | 2.0552 | 83.5 | 432 |
| Example 31 | 79.4 | 0.18 | −4 | 0.13 | 75.0 | 2.0703 | 80.6 | 434 |
| Example 32 | 91.8 | 2.37 | 191 | 2.32 | 71.8 | 2.0818 | 92.6 | 414 |

In each of Working Examples, a glass having a thickness of 1 mm and a composition described in each Example presented in Table 1-1 was manufactured. Then, evaluation was performed using the glass thus manufactured as a sample. Specifically, raw materials having the composition presented in Table 1-1 were uniformly mixed and melted in a gold crucible at 950° C. for two hours to obtain uniform molten glass. Next, the molten glass was poured into a carbon mold having a size of length×width×height=length 60 mm×width 50 mm×height 30 mm. Thereafter, the molten glass was held at 430° C. for one hour, and then cooled to room temperature at a temperature falling rate of about 1° C./min to obtain a glass block. Next, the glass block was cut into a size of 30 mm (length)×30 mm (width) using a cutting machine (small cutting machine manufactured by MARUTO INSTRUMENT CO., LTD.), and the cut glass block was subjected to plate thickness adjustment and surface polishing using a grinding machine (SGM-6301 manufactured by Shuwa Industry Co., Ltd.) and a single-side polishing machine (EJ-380 IN manufactured by Engis Japan Corporation) to manufacture a glass plate having a size of 30 mm (length)×30 mm (width) and a plate thickness of 1 mm.

### Physical Properties

For the glass of each Example, a refractive index n_{d} with respect to visible light, an internal transmittance at a wavelength of 440 nm, and a degradation degree ΔT in a ultraviolet irradiation test were measured.

In the measurement of the refractive index n_{d}, the refractive index n_{d} at a d-line (wavelength: 587.6 nm) of helium was measured for each of the glasses. For the measurement of the refractive index n_{d}, KPR-2000 manufactured by Kalnew was used.

In the measurement of the internal transmittance at a wavelength of 440 nm, the method described in the above embodiment was used.

In the measurement of the degradation degree ΔT, the degradation degree ΔT was calculated by the method described in the above embodiment.

Measurement results of Examples are presented in Table 1-2.

As presented in Table 1-2, the glasses of Examples 1 to 31 (Working Examples) in which the refractive index n_{d} is 1.94 or more, the degradation degree ΔT is 2.2% or less, and the internal transmittance with respect to light having a wavelength of 440 nm is 80% or more each have a high refractive index, and can suppress a decrease in transmittance with respect to visible light. On the other hand, the glass of Example 32 (Comparative Example) that does not satisfy a condition that the degradation degree ΔT is 2.2% or less cannot suppress a decrease in transmittance with respect to visible light.

In addition, a Young's modulus and a wavelength λ₇₀ indicating an internal transmittance of 70% at a plate thickness (thickness) of 10 mm were measured. In the measurement of the Young's modulus, each of the glasses was measured on the basis of propagation of an ultrasonic wave using 38DL PLUS manufactured by OLYMPUS Corporation. The method described in the above embodiment was used to measure the wavelength λ₇₀. Measurement results of the Young's modulus and the wavelength λ₇₀ are also presented in Table 1-2.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A glass having a refractive index of 1.94 or more, an internal transmittance of 70% or more with respect to light having a wavelength of 440 nm at a plate thickness of 10 mm, and a degradation degree ΔT of 2.2% or less in an ultraviolet irradiation test,
wherein the degradation degree ΔT in the ultraviolet irradiation test is obtained by formula (1) below:
$$Δ T ( \% ) = \{ ( {T}_{0} - {T}_{1} ) / {T}_{0} \} \cdot 100 \qquad ( 1 )$$
where
the transmittance T₁ is an external transmittance of the glass with respect to light having a wavelength of 470 nm after a surface of the glass having a thickness of 1 mm is irradiated with ultraviolet rays having a wavelength of 365 nm at a UV illuminance of 50 mW/cm² for ten minutes, and
the transmittance T₀ is an external transmittance of the glass at a wavelength of 470 nm before the irradiation with ultraviolet rays.

2. The glass according to claim 1, wherein a content of Nb₂O₅ is 0% or more and less than 15% in terms of oxide-based mol %.

3. The glass according to claim 1, wherein a content of P₂O₅ is 0% or more and 30% or less and a content of TiO₂ is 0% or more and 30% or less in terms of oxide-based mol %.

4. The glass according to claim 1, wherein a parameter A defined by formula (A) is 270 or less in terms of oxide-based mol %:
$$A = {c ( {P}_{2} {O}_{5} )}^{2} + {c ( {Nb}_{2} {O}_{5} )}^{2} - {c ( {TiO}_{2} )}^{2} \qquad ( A )$$
where
c(P₂O₅) is a content (%) of P₂O₅ in terms of oxide-based mol %,
c(Nb₂O₅) is a content (%) of Nb₂O₅ in terms of oxide-based mol %, and
c(TiO₂) is a content (%) of TiO₂ in terms of oxide-based mol %.

5. The glass according to claim 4, wherein a parameter B defined by formula (B) is 2.5 or less in terms of oxide-based mol %:
$$B = 0.13455 \cdot {2.7183}^{( 0.014912 \cdot A )} . \qquad ( B )$$

6. The glass according to claim 1, comprising boric acid or phosphoric acid.

7. The glass according to claim 1, comprising, in terms of oxide-based mol %,
P₂O₅: 0% or more and 30% or less,
TeO₂: 0.1% or more and less than 40%,
B₂O₃: 0% or more and 40% or less,
Li₂O: 0% or more and 15% or less,
Na₂O: 0% or more and 15% or less,
K₂O: 0% or more and 15% or less,
TiO₂: 0% or more and 32% or less,
Ta₂O₅: 0% or more and 20% or less,
WO₃: 0% or more and 15% or less,
Nb₂O₅: 0% or more and less than 15%,
ZrO₂: 0% or more and 20% or less,
Bi₂O₃: more than 15% and 45% or less
ZnO: 0% or more and 20% or less,
SrO: 0% or more and 20% or less,
La₂O₃: 0% or more and 30% or less, and
SiO₂: 0% or more and 30% or less.

8. The glass according to claim 1, wherein a total content of Fe, Cr and Ni is less than 4 ppm in terms of a mass.

9. The glass according to claim 1, having a thickness of 0.01 mm or more and 2.0 mm or less and a surface area of 8 cm or more.

10. The glass according to claim 1, which is used as a light guide plate.
